(19) United States
(12) Patent Application Publication
(10) Pub. No.: US 2016/0337255 A1
(43) Pub. Date: Nov. 17, 2016

(54) TECHNIQUES FOR FLOW CONTROL FOR DATA COMPRESSION ALGORITHMS

(71) Applicant: QUALCOMM Incorporated, San Diego, CA (US)

(72) Inventors: Srinivasan BALASUBRAMANIAN, San Diego, CA (US); Leena ZACHARIAS, Santa Clara, CA (US); Vishal DALMIYA, San Diego, CA (US); Shailesh MAHESHWARI, San Diego, CA (US); Ashwini RAINA, San Diego, CA (US)

(21) Appl. No.: 15/098,622

(22) Filed: Apr. 14, 2016

Related U.S. Application Data
(60) Provisional application No. 62/162,512, filed on May 15, 2015.

(51) Int. Cl. H04L 12/811; H04L 12/863; H04L 29/06; H04W 72/04

(52) U.S. Cl. CPC H04L 47/38; H04W 72/0413; H04W 72/0486; H04L 47/50; H04L 69/22; H04W 88/02

(57) ABSTRACT

In some examples, the method and apparatus may comprise dynamically scaling the packet compression procedures based on available system resources. For example, as the available resource capacity (e.g., processing power, bus bandwidth and/or memory) decreases, aspects of the present disclosure may dynamically adjust the usage of the packet compression procedures on one or more data packets to maximize available resources and achieve optimal compression gains.

### CROSS-REFERENCE TO RELATED APPLICATION(S)

This application claims priority to U.S. Provisional Application Serial No. 62/162,512, entitled, “TECHNIQUES FOR FLOW CONTROL FOR DATA COMPRESSION ALGORITHMS,” and filed on May 15, 2015, which is assigned to the assignee hereof and hereby expressly incorporated by reference herein in its entirety.

### BACKGROUND

The present disclosure relates generally to communication systems, and more particularly, to a method, system, and apparatus for dynamically adapting data compression procedures based on available resource capacity of user equipment (UE).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology.

Generally, wireless communications systems, in order to maximize available bandwidth, may compress packets prior to transmitting them over a communication link. However, compressing packets scheduled for transmission may cost system resources, such as but not limited to processing power, bus bandwidth, and/or memory. In some cases, such as during periods of peak throughput, available system resources may be rather limited. Thus, redirecting such limited system resources to compress transmission packets may negatively impact overall system performance.

### SUMMARY

In an aspect of the disclosure, a method, user equipment, and a computer readable medium are provided. In some examples, the aspects may comprise dynamically scaling packet compression procedures based on available system resources. For example, as the available resource capacity (e.g., processing power, bus bandwidth and/or memory) decreases, aspects of the present disclosure may dynamically adjust the usage of the packet compression procedures on one or more data packets to maximize available resources and achieve optimal compression gains.

In some aspects, a method for flow control associated with uplink data compression in a wireless communication system is disclosed. The method may include calculating, by a processor, an available resource capacity of a UE. The method may further include determining whether to adjust usage of a packet compression procedure on one or more data packets for transmission based on the available resource capacity. In some aspects, the method may include generating one or more transmission data packets from the one or more data packets for transmission based on the determination. In some aspects, each transmission data packets may include a packet header and a payload. The packet header may identify a compression state. In one or more examples, the method may further include transmitting, via a transceiver, the one or more transmission data packets to a network device.

In another aspect, an apparatus for flow control associated with uplink data compression in a wireless communication system is disclosed. The apparatus may include a processor and a memory coupled to the processor. The memory may include instructions executable by the processor to calculate an available resource capacity of a UE. The instructions may further be executable by the processor to determine whether to adjust usage of a packet compression procedure on one or more data packets for transmission based on the available resource capacity. In some aspects, the instructions may further be executable by the processor to generate one or more transmission data packets from the one or more data packets for transmission based on the determination. In some aspects, each transmission data packets may include a packet header and a payload. The packet header may identify a compression state. In one or more examples, the instructions may further be executable by the processor to transmit the one or more transmission data packets to a network device.

In another aspect, a user equipment for flow control associated with uplink data compression in a wireless communication system is disclosed. The apparatus may include means for calculating an available resource capacity of a UE. The apparatus may further include means for determining whether to adjust usage of a packet compression procedure on one or more data packets for transmission based on the available resource capacity. In some aspects, the apparatus may include means for generating one or more transmission data packets from the one or more data packets for transmission based on the determination. In some aspects, each transmission data packets may include a packet header and a payload. The packet header may identify a compression state. In one or more examples, the apparatus may further include means for transmitting the one or more transmission data packets to a network device.

In another aspect, a computer-readable medium storing code for flow control associated with uplink data compression in a wireless communication system is disclosed. The code may comprise instructions executable to calculate an available resource capacity of a UE. The code may comprise instructions executable to determine whether to adjust usage of a packet compression procedure on one or more data packets for transmission based on the available resource capacity. In some aspects, code may comprise instructions executable to generate one or more transmission data packets from the one or more data packets for transmission based on the determination. In some aspects, each transmission data packets may include a packet header and a payload. The packet header may identify a compression state. In one or more examples, code may comprise instructions executable to transmit the one or more transmission data packets to a network device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIG. 1 is a diagram illustrating an example of network architecture in which the present aspects may operate.

FIG. 2 is a diagram illustrating an example of an access network in accordance with various aspects of the present disclosure.

FIG. 3 is a diagram illustrating an example of a DL frame structure in LTE in accordance with various aspects of the present disclosure.

FIG. 4 is a diagram illustrating an example of an UL frame structure in LTE in accordance with various aspects of the present disclosure.

FIG. 5 is a block diagram of an example of a Node B in communication with a UE in a telecommunications system configured to perform the functions describe herein.

FIG. 6 is one example of dynamically adapting data compression procedures based on available resource capacity in accordance with various aspects of the present disclosure.

FIG. 7A illustrates an example uplink data compression (UDC) packet format in accordance with various aspects of the present disclosure.

FIG. 7B illustrates another example of UDC packet format in accordance with various aspects of the present disclosure.

FIG. 8 is a flow chart of a method of wireless communication implemented on a user equipment in accordance with various aspects of the present disclosure.

FIG. 9 is a conceptual data flow diagram illustrating the data flow between different modules/means/components in an exemplary user equipment in accordance with various aspects of the present disclosure.

FIG. 10 is a diagram illustrating an example of a hardware implementation for a user equipment in accordance with various aspects of the present disclosure.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The number of people using smart phones is increasing globally, resulting in increased data consumption over wireless networks (e.g., such as HSPA or LTE networks). In conjunction with the rise in smart phone usage, is an increase in expectations of users with regard to the quality of service of their smart phones. One way to help ensure better user experience involves over the air data traffic compression.

Data compression may be used for both uplink transmissions as well as downlink transmissions. For ease of discussion, the following disclosure may mainly refer to uplink data compression (UDC), but it should be understood that the stated principles may equally apply to downlink data compression (DDC). Data compression, such as UDC or DDC, aims to reduce the size of uplink or downlink data packets including, but not limited to, transport control protocol (TCP) headers, user datagram protocol (UDP) headers, Internet protocol (IP) headers, and data fields or payloads, for example. In UDC, the user device (e.g., such as user equipments (UEs)) compresses the data, which may then be decompressed at a receiving end, for example, a network entity such as, but not limited to, an eNodeB, or a core network entity, or a destination device such as another user equipment or a server on a network.

UDC may enable shorter transmit durations and low transmit power, which in turn may result in reduced interference, system capacity gains, and better user experience. UDC is performed by compressing packet headers and/or payloads based on prior packets sent. For example, a memory such as an uplink (UL) Compression Memory may be employed at both the transmitter and/or receiver side to remember past packets. Looking at the existing memory, repetitive strings in the prior packets may be identified and matched to strings in current packets. Matched blocks of data (e.g., bytes) in the current packet may be replaced with Pointer Metadata that points to a location in the UL Compression Memory of a block of matched bytes.

Compressing each of the one or more data packets scheduled for transmission may require extensive system resources. However, during certain time periods, system resources (e.g., processing resources, bus bandwidth, and available memory) may be scarce. As a result, diverting such limited resources to compress uplink data may result in overall system degradation.

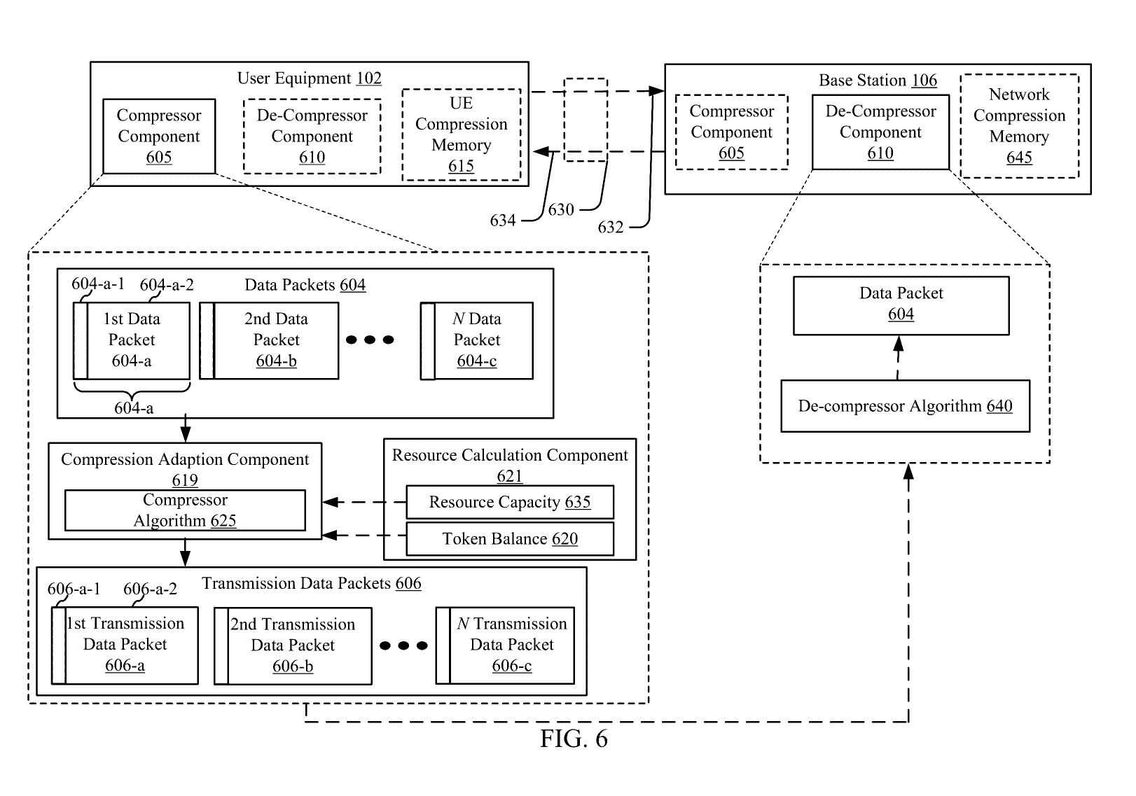

Aspects of the present disclosure resolve such issues by dynamically adjusting packet compression procedures by considering available resource capacity or token balance (see FIG. 6) that may proactively limit over utilization of system resources. Additionally or alternatively, aspects of the present disclosure maintain optimal compression gains by selectively updating compression memory to reduce signaling overhead. In other words, the present aspects may operate to control the flow of data packets to be transmitted through a compressor based on dynamically adjusting packet compression procedures according to available resource capacity in order to avoid over-utilizing the available resource capacity.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

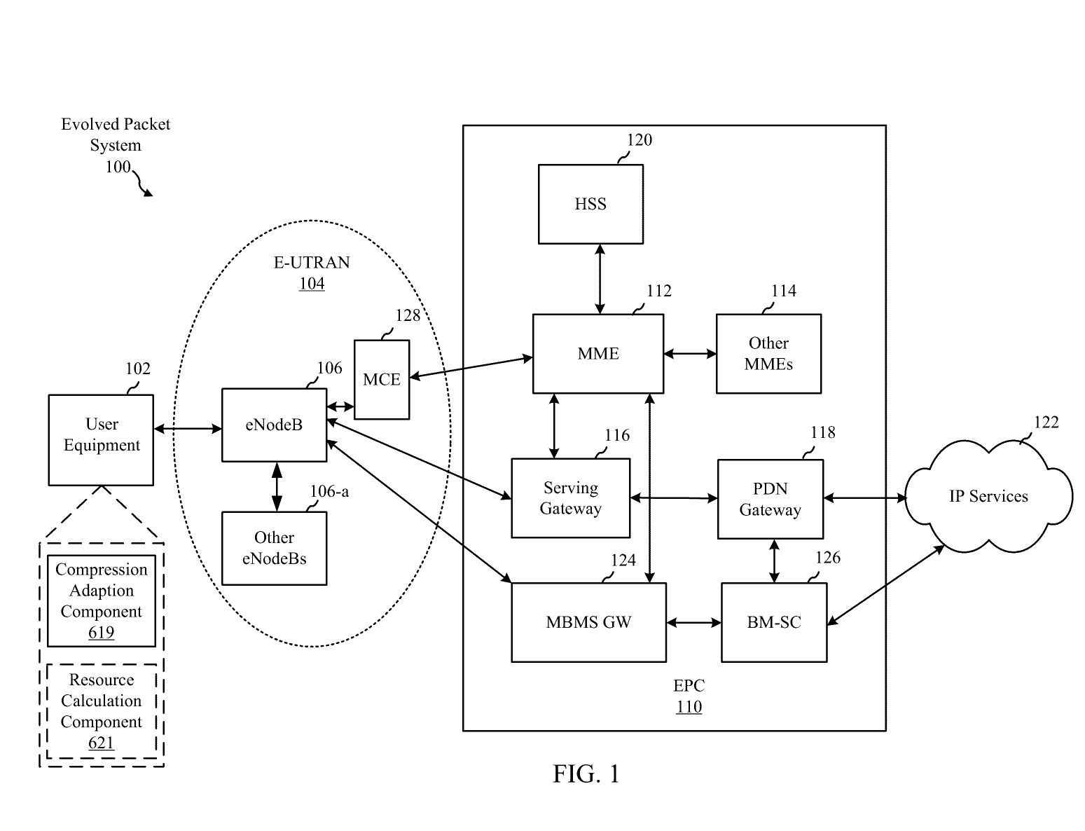

FIG. 1 is a diagram illustrating an LTE network architecture including a user equipment (UE) 102 having a compression adaption component 619 to manage a flow control of data packets associated with an uplink data compression, which in some aspects may be based on available resource capacity determined by resource calculation component 621, as discussed in more detail below (see FIG. 6 and subsequent figures and corresponding discussion). The LTE network architecture may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 106-a, and may include a Multicast Coordination Entity (MCE) 128. The eNB 106 provides user and control planes protocol terminations toward the UE 102. The eNB 106 may be connected to the other eNBs 106-a via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

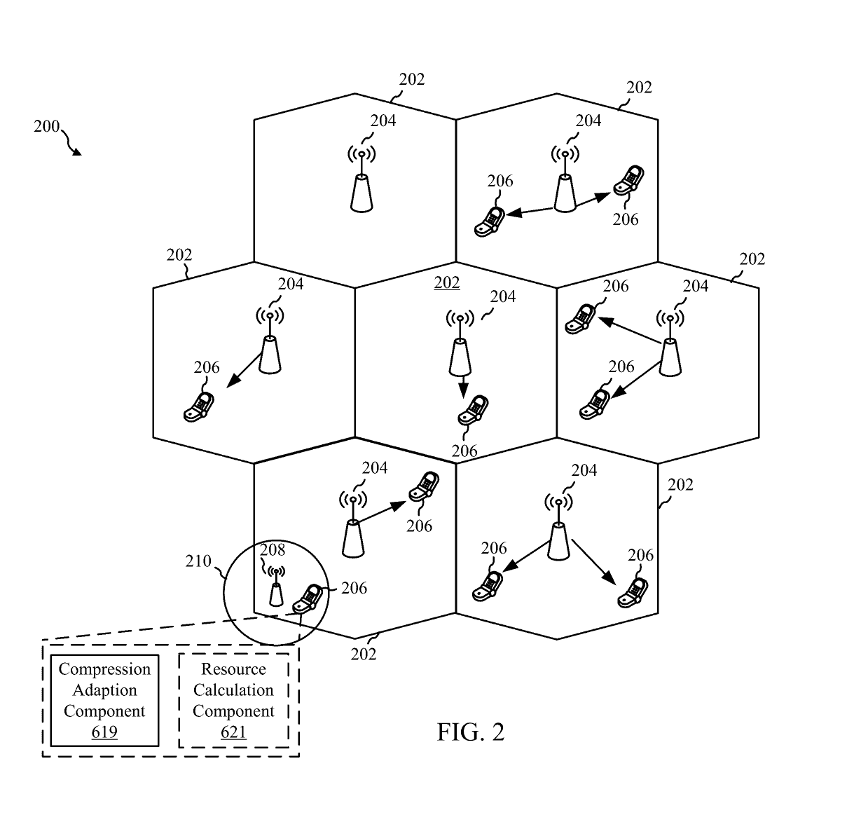

FIG. 2 is a diagram illustrating an example of an access network 200 in an LTE network architecture including one or more UEs 206 having compression adaption component 619 to manage a flow control of data packets associated with an uplink data compression, which in some aspects may be based on available resource capacity determined by resource calculation component 621, as discussed in more detail below (see FIG. 6 and subsequent figures and corresponding discussion). In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

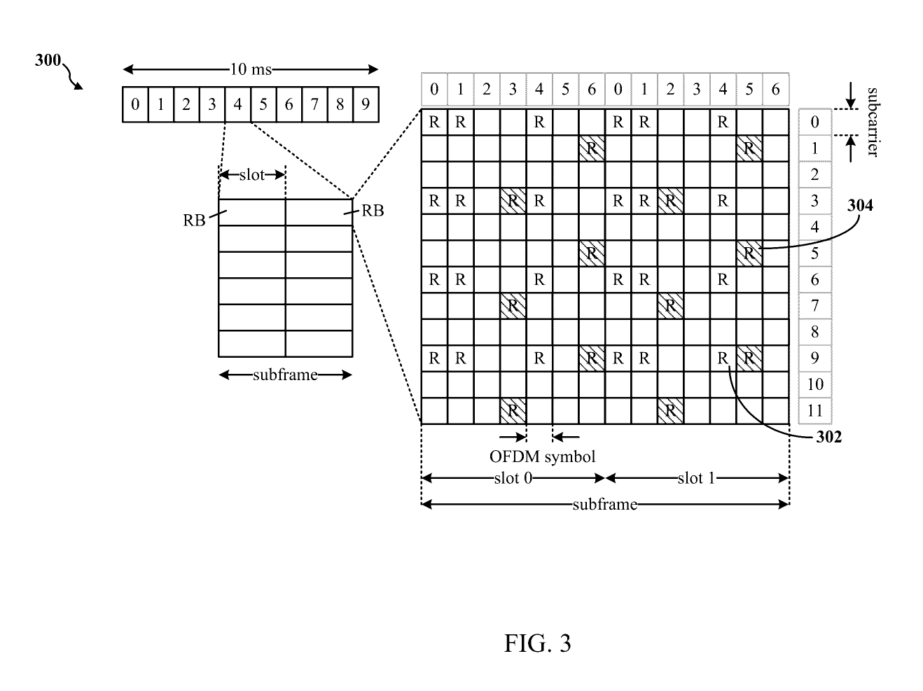

FIG. 3 is a diagram 300 illustrating an example of a DL frame structure in LTE, which may be used by a network entity, e.g., an eNodeB, transmitting signals to a UE, where the transmitted signals may include compressed data as discussed herein. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

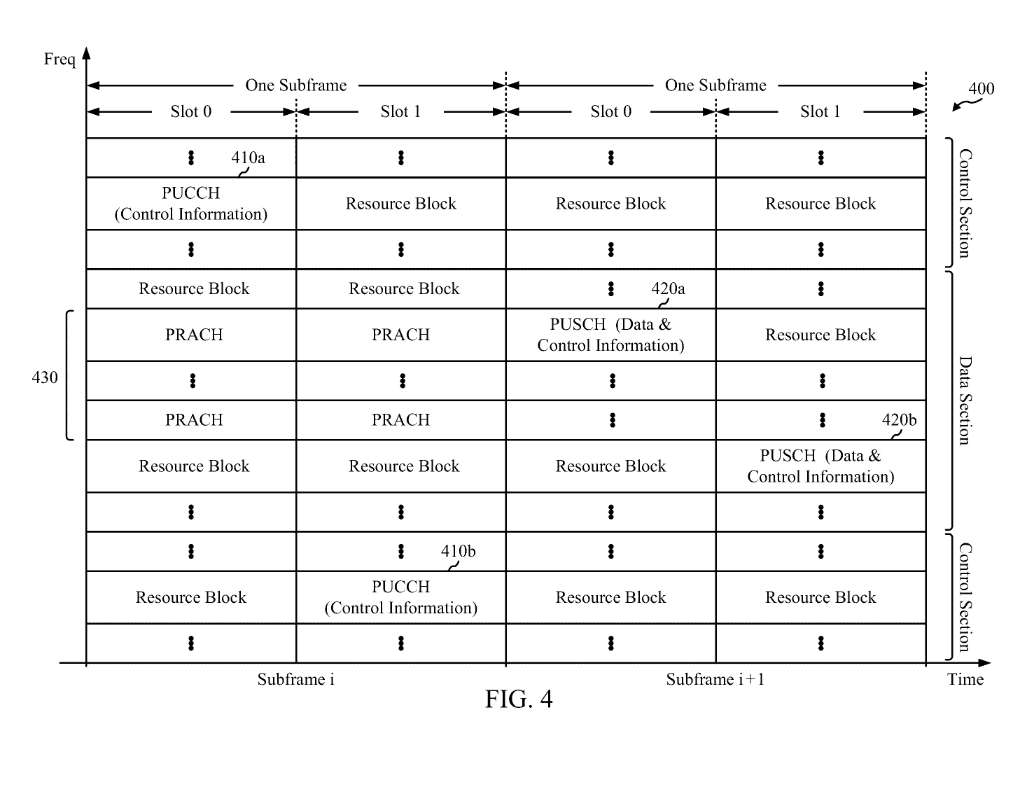

FIG. 4 is a diagram 400 illustrating an example of an UL frame structure in LTE, which may be used by a UE transmitting signals to a network entity, e.g., an eNodeB, where the transmitted signals may include compressed data as discussed herein. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

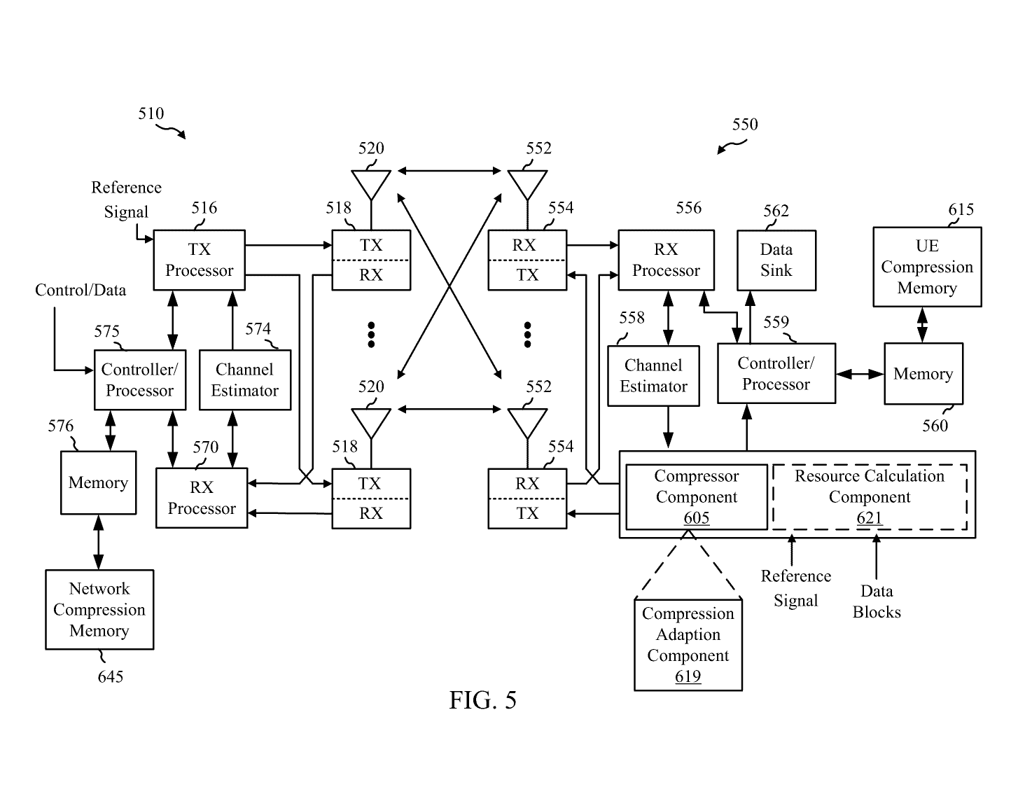

FIG. 5 is a block diagram of an eNB 510 in communication with a UE 550 in an access network, where UE 550 includes compression adaption component 619 to manage a flow control of data packets associated with an uplink data compression as discussed herein. In the DL, upper layer packets from the core network are provided to a controller/processor 575. The controller/processor 575 implements the functionality of the L2 layer. In the DL, the controller/processor 575 provides header compression, ciphering, packet segmentation and reordering, multiplexing between logical and transport channels, and radio resource allocations to the UE 550 based on various priority metrics. The controller/processor 575 is also responsible for HARQ operations, retransmission of lost packets, and signaling to the UE 550.

The transmit (TX) processor 516 implements various signal processing functions for the L1 layer (i.e., physical layer). The signal processing functions include coding and interleaving to facilitate forward error correction (FEC) at the UE 550 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the UE 550. Each spatial stream may then be provided to a different antenna 520 via a separate transmitter 518TX. Each transmitter 518TX may modulate an RF carrier with a respective spatial stream for transmission.

At the UE 550, each receiver 554RX receives a signal through its respective antenna 552. Each receiver 554RX recovers information modulated onto an RF carrier and provides the information to the receive (RX) processor 556. The RX processor 556 implements various signal processing functions of the L1 layer. The RX processor 556 may perform spatial processing on the information to recover any spatial streams destined for the UE 550. If multiple spatial streams are destined for the UE 550, they may be combined by the RX processor 556 into a single OFDM symbol stream. The RX processor 556 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 510. These soft decisions may be based on channel estimates computed by the channel estimator 558. The soft decisions are then decoded and deinterleaved to recover the data and control signals that were originally transmitted by the eNB 510 on the physical channel. The data and control signals are then provided to the controller/processor 559.

The controller/processor 559 implements the L2 layer. The controller/processor can be associated with a memory 560 that stores program codes and data. The memory 560 may be referred to as a computer-readable medium. In the UL, the controller/processor 559 provides demultiplexing between transport and logical channels, packet reassembly, deciphering, header decompression, control signal processing to recover upper layer packets from the core network. The upper layer packets are then provided to a data sink 562, which represents all the protocol layers above the L2 layer. Various control signals may also be provided to the data sink 562 for L3 processing. The controller/processor 559 is also responsible for error detection using an acknowledgement (ACK) and/or negative acknowledgement (NACK) protocol to support HARQ operations.

In the UL, a data source 567 is used to provide upper layer packets to the controller/processor 559. The data source 567 represents all protocol layers above the L2 layer. Similar to the functionality described in connection with the DL transmission by the eNB 510, the controller/processor 559 implements the L2 layer for the user plane and the control plane by providing header compression, ciphering, packet segmentation and reordering, and multiplexing between logical and transport channels based on radio resource allocations by the eNB 510. The controller/processor 559 is also responsible for HARQ operations, retransmission of lost packets, and signaling to the eNB 510.

In accordance with aspects of the present disclosure, the UE 550 may additionally include a compressor component 605, compression adaption component 619, and, optionally, resource calculation component 621 (see FIGS. 6 and subsequent figures and corresponding description). The compressor component 605 may execute compression adaption component 619 to dynamically adjust the usage of the packet compression procedures on one or more data packets queued for transmission, and in some cases the adjustment may be based on the available resource capacity calculated by the resource calculation component 621. The compressor component 605 may forward the transmission blocks to the transceiver to component to the eNB 510.

Channel estimates derived by a channel estimator 558 from a reference signal or feedback transmitted by the eNB 510 may be used by the TX processor to select the appropriate coding and modulation schemes, and to facilitate spatial processing. The spatial streams generated by the TX processor 568 may be provided to different antenna 552 via separate transmitters 554TX. Each of the one or more transmitters 554TX may modulate an RF carrier with a respective spatial stream for transmission.

The UL transmission is processed at the eNB 510 in a manner similar to that described in connection with the receiver function at the UE 550. Each receiver 618RX receives a signal through its respective antenna 520. Each receiver 518RX recovers information modulated onto an RF carrier and provides the information to a RX processor 570. The RX processor 570 may implement the L1 layer.

The controller/processor 575 implements the L2 layer. The controller/processor 575 can be associated with a memory 576 that stores program codes and data. The memory 576 may be referred to as a computer-readable medium. The eNB may also include a network compression memory 645 (see FIG. 6) that may be synchronized the UE compression memory 615 (see FIG. 6). In the UL, the controller/processor 575 provides demultiplexing between transport and logical channels, packet reassembly, deciphering, header decompression, control signal processing to recover upper layer packets from the UE 550. Upper layer packets from the controller/processor 575 may be provided to the core network. The controller/processor 575 is also responsible for error detection using an ACK and/or NACK protocol to support HARQ operations.

Referring to FIG. 6, in one aspect, a wireless communication system is configured to facilitate communication between user equipment 102 and network device (e.g., base station 106). In some aspects, the user equipment 102 and the base station 106 may be an example of one or more UEs and base stations described with reference to FIGS. 1-5. The UE 102 may communicate wirelessly with one or more base stations 106 over one or more wireless link 630. The one or more wireless links 630 may include, but are not limited to, signaling radio bearers and/or data radio bearers. The base station 106 may be configured to transmit one or more signals 634 to the UE 102 over the one or more wireless link 125, and/or UE 102 may transmit one or more signals 632 to the base station 106. In an aspect, signal 632 and signal 6344 may include, but are not limited to, one or more messages, such as transmitting a data packet or a packet data flow from the UE 102 to the base station 106. In some examples, the UE 102 and/or the base station 106 may include a compressor component 605 and a de-compressor component 610. Functionalities of the compressor component 605 and/or the de-compressor component 610 may be performed by either the UE 102 and/or the base station 106.

In accordance with aspects of the present disclosure, the UE 102 may execute a compression adaption component 619 to manage a flow of data packets 604 associated with an uplink data compression in a wireless communication system. For example, the compressor component 605 may receive one or more data packets 604 for transmission. In some examples, the one or more data packets 604 may be uncompressed data packets, or data packets having some uncompressed portion. However, as discussed above, compressing each of the one or more data packets 604 for transmission to the base station 106 may be resource intensive. Thus, during periods of high peak throughput, for example, diverting system resources (e.g., processing capability, bus bandwidth, available memory, etc.) to perform packet compression procedure(s) may negatively impact the overall system performance.

Accordingly, aspects of the present disclosure are configured to provide a method for dynamically scaling and adjusting the usage of the packet compression procedures on the one or more data packets 604, which may be based on the available resource capacity as determined by execution of resource calculation component 621. In some aspects, one or more data packets 604 may include a packet header 604-a-1 and a payload 604-a-2, for example. UE 102 and/or resource calculation component 621, in accordance with various aspects of the present disclosure, may calculate the available resource capacity 635 and provide the relevant information to the compressor algorithm 625. Calculating the available resource capacity 635 may include identifying one or more resource capacity parameters, such as but not limited to one or more of the CPU load, bus bandwidth, available memory, or thermal measurements associated with the UE 102. In some examples, each or some combination of the above-identified parameters (e.g., CPU load, bus bandwidth, etc.) may be assigned a weight value that is fixed or dynamically configurable for use in determining the available resource capacity that takes into account a combination of parameters. For example, in some cases, the CPU load may be weighted higher than the available memory when calculating the available resource capacity. Accordingly, based on the measurements and/or calculations, the UE 102 and/or resource calculation component 621 may identify available resource capacity 635 of the UE 102.

Based on the available resource capacity 635, compression adaption component 619 may determine whether to adjust usage of a packet compression procedure, e.g., including one or more compressor algorithms 625, on one or more data packets 604 for transmission. For instance, determining whether to adjust usage of a packet compression procedure may include determining whether the available resource capacity 635 satisfies a capacity threshold. The capacity threshold may be either fixed threshold value or a dynamically adaptable threshold value. If the available resource capacity exceeds the capacity threshold, the compression adaption component 619 may enable a packet compression procedure to perform compression on one or more data packets 604 queued for transmission. Alternatively, if the available resource capacity 635 is less than the capacity threshold, compression adaption component 619 may disable the packet compression procedure. Additionally, in some aspects, compression adaption component 619 may scale the level or type of compression performed on the one or more data packets 604 based on active monitoring of the available resource capacity 635, e.g., by dynamically adjusting the one or more compressor algorithms 625 at varying levels of available resource capacity 635.

For example, in some aspects, the UE 102 may adjust the one or more compressor algorithms 625 to a first compression state if the available resource capacity fails to satisfy a first capacity threshold, and adjust the one or more compressor algorithms 625 from the first compression state to a second compression state if the available resource capacity further fails to satisfy a second capacity threshold. In the aforementioned example, the first capacity threshold may be higher than the second capacity threshold (e.g., available resource capacity 635 may be higher during the first capacity threshold than a subsequent second capacity threshold). Thus, in accordance with various aspects of the present disclosure, an amount of compression performed during the first compression state may be greater than the amount of compression performed during the second compression state.

Some examples of the first compression state may include compressing each of the one or more data packets 604 scheduled for transmission, while the second compression state may include compressing a subset of the one or more data packets 604 (e.g., compressing the 1^{st} data packet 604-a and the 2^{nd} data packet 604-b, while leaving the N^{th} data packet 604-c uncompressed). Thus, in this example of the second compression state, the UE 102 may transmit to the base station 106 some data packets that are compressed and other data packets that may be uncompressed. Additionally or alternatively, the second compression state may include compressing a first portion of a first data packet 604-a (e.g., first packet header 604-a-1) of the one or more data packets 604, while a second portion (e.g., first packet payload 604-a-2) of the first data packet 604-a may be left uncompressed. In one or more examples, the compressed portion may be a packet header and the uncompressed portion may be the payload. Alternatively, in other examples, the compressed portion may be the packet payload (e.g., first packet payload 604-a-2), while the uncompressed portion may be the packet header (e.g., first packet header 604-a-1). Thus, in this example of the second compression state, the UE 102 may transmit to the base station 106 data packets that have a portion of compressed data and another portion of uncompressed data. Another example of the second compression state may be a combination of the above two examples, such that the UE 102 may transmit to the base station 106 some data packets that are compressed, and other data packets that may be uncompressed, and as well as some data packets that have a portion of compressed data and another portion of uncompressed data. Accordingly, in some examples, the first portion or multiple portions of the first data packet 604-a may be compressed. In any case, the one or more compressor algorithms 625 may perform packet compression procedures on the one or more data packets 604 to generate one or more transmission data packets 606. The one or more transmission data packets 606 may also include a transmission packet header (e.g., first transmission data packet header 606-a-1) and a transmission packet payload (e.g., first transmission data packet payload 606-a-2). The transmission data packet header 606-a-1 may identify the compression state of the transmission data packet 606-a.

Additionally or alternatively, compression adaption component 619 may determine whether to adjust usage of a packet compression procedure provided by the one or more compressor algorithms 625 based on a token balance 620. In some aspects, token balance 620 may be a value that is representative of a level of resource capacity 635. In this case, token balance 620 may be another version of resource capacity 635. In other aspects, token balance 620 may be a configurable level of usage of the resource capacity, or, in other words, a cap or limit on how much resources may be used by compressor component 605. In some examples, the UE 102 and/or resource calculation component 621 may maintain a token balance 602 for accumulating tokens at a fixed or configurable rate (e.g., 1 Mbps acquired every 20 ms) that may avoid overloading system resources. Thus, such an approach may proactively prevent the available resource capacity from falling below ideal threshold limits. Accordingly, in some aspects, the token accumulation may limit the amount of data (e.g., packet header 604-a-1 and payload 604-a-2) that may be compressed by the compression adaption component 619.

In some examples, the UE 102 and/or compression adaption component 619 may determine whether to adjust usage of a packet compression procedure provided by the one or more compressor algorithms 625 by determining a data packet length associated with a first data packet 604-a of the one or more data packets 604, and enable the packet compression procedure when a token balance at the UE 102 exceeds the data packet length. Alternatively, the UE 102 may disable the packet compression procedure when the token balance is less than or equal to the data packet length of the first data packet 604-a. Alternative to an enable/disable procedure that may either turn “on” or “off” packet compression procedures, features of the present disclosure may also adjust the amount of compression performed on each of the one or more data packets 604 based on a combination of the resource capacity 635 and/or the token balance 620 accumulated by the UE 102. Thus, in some examples, the compressor algorithm 625 may determine whether the token balance (e.g., 500 bytes) accumulated by the UE 102 is less than the size of a packet header 604-a-1 (e.g., 1000 bytes) associated with the first data packet 604-a. If the token balance 620 falls below the length of the packet header 604-a-1, the compressor algorithm 625 may avoid compressing the first data packet 604-a. In such an instance, the compressor algorithm 625 may generate an uncompressed first transmission data packet 606-a from the first data packet 604-a for transmission to the base station 106.

Alternatively, if the token balance 620 (e.g., 1500 bytes) in the token bucket exceeds (or is equal) to the length of the packet header 604-a-1 (e.g., 1000 bytes) associated with the first data packet 604-a, while being less than the length of the first data packet 604-a (i.e., combination of packet header 604-a-1 and payload 604-a-2), the compressor algorithm 625 may compress only the packet header 604-a-1 while leaving the packet payload 604-a-2 associated with the first data packet 604-a uncompressed. Therefore, in such instance, the first transmission data packet 606-a may include a first portion (i.e., the transmission data packet header 606-a-1) that may be compressed, while the second portion (i.e., the transmission data packet payload 606-a) associated with the first transmission data packet 606-a may be uncompressed. In other words, the UE may compress the header of the first data packet when the token balance exceeds the packet header length.

In some cases, when the token balance (e.g., 1500 bytes) is less than the length of the data packet (e.g., 2000 bytes), the compressor algorithm 625 may either partially compress the first data packet 604-a based on the token balance 620 and/or enter a wait period (e.g., additional 20 ms) to accumulate additional tokens (e.g., 2500 bytes at a rate of 1 Mbps every 20 ms). In further examples, if the token balance (e.g., 1500 bytes) acquired by the UE 102 exceeds the data packet length of the first data packet 604-a (e.g., 1000 bytes), the compressor algorithm 625 may compress the entire first data packet 604-a to form a first transmission data packet 606-a, and thus charge the appropriate amount of token (i.e., 1000 bytes) from the token balance (i.e., 500 remaining token balance). As a result, aspects of the present disclosure may utilize one or more of the token balance 620 and/or the resource capacity 635 measurements to determine whether to adjust usage of the packet compression procedures on one or more data packets 604 for transmission.

Once the compression adaption component 619 associated with the UE 102 has determined whether to adjust the usage of the compressor algorithm 625 and the level of adjustment to apply based on one or more of the token balance 620 and the resource capacity 635, the compression adaption component 619 may generate one or more transmission data packets 606 from the data packets 604 queued for transmission. Generating the one or more transmission data packets 606 may comprise identifying an N number of the one or more data packets 604-c queued for transmission, and selecting a K number (e.g., first data packet 604-a) of the one or more data packets for compression from the N number of the one or more data packets 604-c. In some aspects, the N value and the K value may be integers where N is greater than K Thus, in some aspects compression adaption component 619 may select only a subset of the total number of data packets 604 for compression (e.g., selecting two (2) out of the six (6) total data packets 604). In other words, the compression adaption component 619 may compress only K number out of N packets over a certain duration of time. Accordingly, the compression adaption component 619 may compress the K number of the one or more data packets 604 based on the selection. In some examples, the selection of the K number of the one or more data packets 604 (i.e., the subset number of data packets from the total data packets 604) may be based on a fixed pattern (e.g., selecting every alternative data packet) or a pseudo-random pattern. In some aspects, the UDC header in the packet may identify (e.g., signal to the base station) whether the packet is compressed or uncompressed. In some cases, the value of K may be zero such that all N packets may be uncompressed. In such instances, the UDC may be disabled until system resource use returns to normal. In some aspects, the PDCP control PDU with disable and enable inform the receiver of the UE actions.

Additionally or alternatively, generating the one or more transmission data packets 606 may comprise compressing a portion of each of the data packets 604 to form the one or more transmission data packets 606. Thus, in some instances, each of the transmission data packets 606 may include a compressed portion, an uncompressed portion, or any combination thereof. In some examples, the compressed portion may be the packet header 606-a-1 and the uncompressed portion may be the packet payload 606-a-2. In other examples, the compressed portion may be the packet payload 606-a-2, while the packet header 606-a-1 may be uncompressed. In yet further example, a first portion of the payload 606-a-2 may be compressed, while a second portion of the payload 606-a-2 may be uncompressed. Thus, aspects of the present disclosure may dynamically adjust the level of packet compression applied on the one or more data packets 604 based on considerations such as resource capacity 635 and/or token balance 620. Thus in some aspects, the UE may reduce size of packet on which compression is attempted by compressing only a subset of the total packet size (e.g., 5 bytes of the 10 bytes). This may be applicable for both full packets and packet header only compression. For full packet compression, the length of the packet on which the compression may be attempted may be less than equal to the total length of the packet even though the entire packet is pushed into the compression memory. In contrast, for the packet header only compression, the length of the packet on which the compression is attempted may be less than equal to packet header length even though the entire packet header is pushed into the compression memory. By compressing only part of the packets, the cost of compression in terms of system resources may be significantly reduced.

As a non-limiting example, the UE may determine whether to perform compression adaption based on the resource capacity, for example, if the CPU load is below 70%, the UE may perform full compression on all packets. However, if the CPU load is greater than 70%, the UE may compress half the packets or 500 bytes (whichever is less). Further, if the CPU load is greater than 80%, the UE may compress only the header. If the CPU load exceeds 85%, the UE may compress only 25% of the number of packets. Finally, if the CPU load exceeds 90%, the UE may cease all compression of all packets in order to conserve system resources for a predetermined time period.

In yet further examples of the present disclosure, the UE 102 and/or compression adaption component 619 may selectively update the UE compression memory 615 to maximize compression gains. Compression gain may be measured against a gain threshold value that represents a point at which the gain from performing compression may not be worth the cost, in terms of processing resources and/or communication overhead in transmitting compressed data flow. Thus, aspects of the present disclosure manage optimal compression gains by selectively updating the UE compression memory 615 based on adjustments applied by the compression adaption component 619 on the packet compression procedures for the one or more data packets 604. In some aspects, a compression memory (e.g., UE compression memory 615 and Network compression memory 645) may be employed at both the transmitter and/or receiver side to remember past packets. Looking at the existing memory, repetitive strings in the prior packets may be identified and matched to strings in current packets. Matched blocks of data (e.g., bytes) in the current packet may be replaced with Pointer Metadata that points to a location in the compression memory (e.g., UE compression memory 615 and Network compression memory 645) of a block of matched bytes. However, updating the compression memory for each transmission data packet may be resource intensive. Thus, in some examples, the UE 102 and/or compression adaption component 619 may selectively add one or more uncompressed transmission data packets (e.g., second transmission data packet 606-b) or a portion of the uncompressed transmission data packet (e.g., first transmission data packet payload 606-a-2) to the UE compression memory 615. Accordingly, the UE 102, may signal to the network device (e.g., base station 106) via one or more transmission data packet headers 606-a-1, for example, the portion and the location of the data packet that has been stored in the UE compression memory 615. Based on the signaling information, the base station 106 may update the network compression memory 645 to mirror the UE compression memory 615. Thus, in some aspects, the UE 102 may selectively add or update packets/part of the packets to UE compression memory 615. In some examples, the UE 102 may compress all N packets, but add only K packets to the UDC compression memory. In such instance, the header extension may indicate that the packet need not be pushed to memory. In some aspects, the packets added to the UDC compression memory may be randomly chosen or based on the percentage of compression. In other examples, the UE 102 may compress all N packets, but add selective portions of each packet to the UDC memory. In such instance, the header extension may indicate that compression has been attempted on entire packet but selected segments of the packet need to be pushed to memory.

Accordingly, the base station 106 may employ the signaling information associated with the compression memory to decode and/or reassemble data packets 604 using a de-compressor algorithm 640 and referencing the network compression memory 645 based on Pointer Metadata that point to a location in the network compression memory 645 of a block of matched bytes.

In yet further examples, the UE 102 and/or compression adaption component 619 may include monitoring the UE compression memory 615 to detect memory overload conditions and determining whether to disable the packet compression procedures based on detecting an memory overload condition. In some examples, the compression adaption component 619 may resolve the memory overload condition by releasing the compression memory and thereafter continuing to monitor the compression memory to determine whether an available memory level meets an available memory threshold associated with avoidance of the memory overload condition. If the available memory level returns to an available memory threshold, the UE 102 may enable the packet compression procedures and reset the UE compression memory 615 to start afresh.

Additionally or alternatively, the base station 106 may also compress one or more data packets for transmission to the UE 102 over communication link 630. Accordingly, the UE 102 may utilize de-compressor component 610 to decompress one or more packets from the base station 106 for processing. However, if the resource capacity 635 at the UE 102 is limited, the UE 102 may be unable to adequately redirect resources such as processing time, bus bandwidth and/or memory to decompress the arriving data packets. As such, in some examples, the UE 102 may transmit a control message 632 over communication link 630 to request the base station 106 to adjust its respective packet compression procedures to account for the limited resources at the UE 102.

In some examples, the UE 102 and/or resource calculation component 621 may calculate the available resource capacity 635 associated with the UE 102 and determine whether to request the base station 106 to adjust usage of a packet compression procedures at the network side on one or more data packets scheduled for transmission to the UE 102. Accordingly, the UE 102 may select optimal packet compression procedures and identify such procedures in the control message to the base station 106 to implement for transmission of data packets from the base station 106 to the UE 102.

In yet further examples, aspects of the present disclosure may maximize compression gains by utilizing compression techniques for data compression (e.g., uplink data compression (UDC) that may utilize less system resources than traditional compression formats. In some aspects, the UE 102 and/or compression adaption component 619 may implement a UDC compression format that uses string comparison to compare the current packet bytes to previous packet to obtain potential matches prior to performing the compression based on finding matches in the full UE compression memory on the one or more data packets 604. If the string comparison results in a positive match, the compression adaption component 619 may avoid further processing and compressing data packets that will search in the full UE compression memory (i.e., UE compression memory 615 and the network compression memory 645) to find matches. Thus, compression gains may be achieved by searching in known parts of UE compression memory to reduce the usage of system resources.

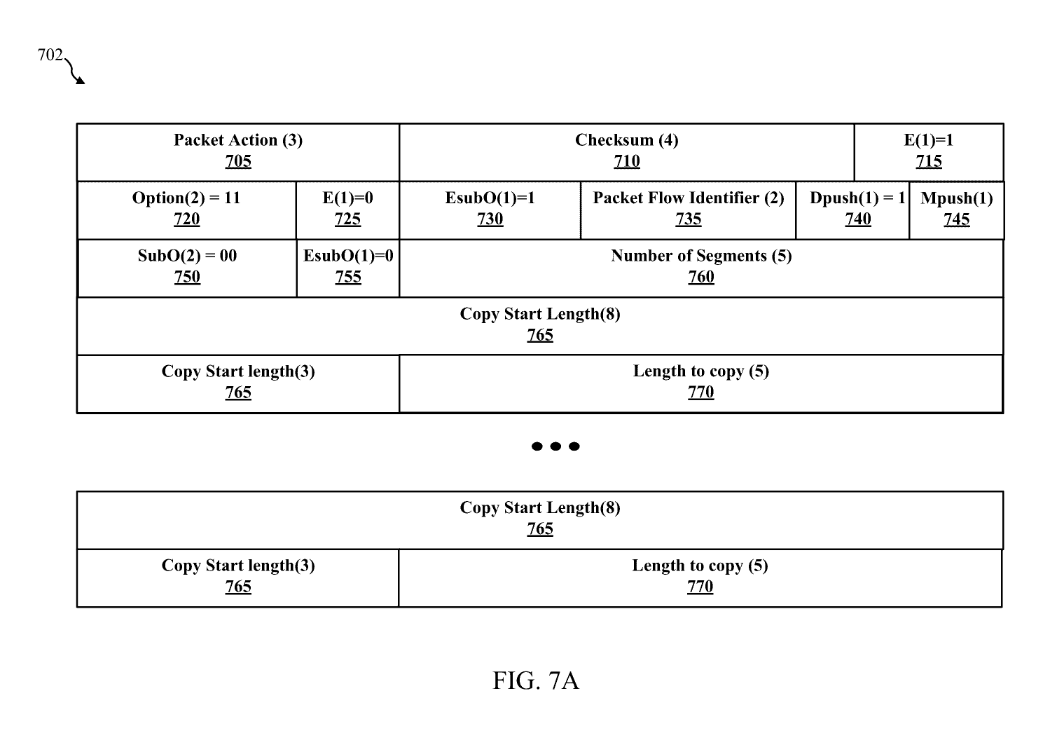

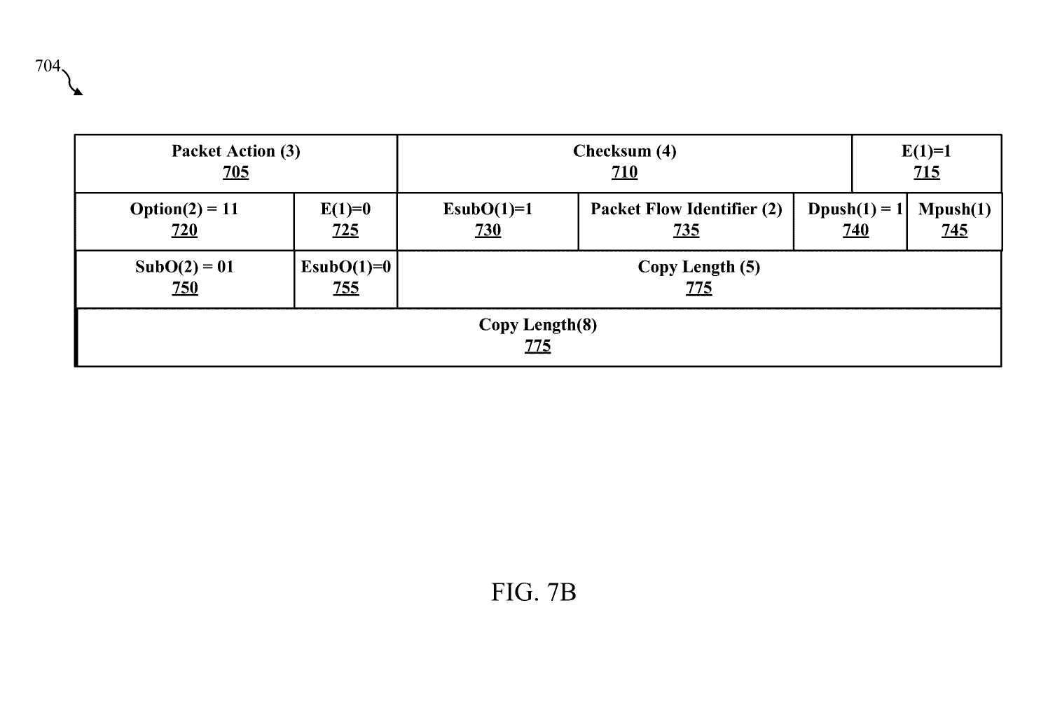

FIG. 7A illustrates an example UDC packet format 702 that may be utilized to signal to the receiver (e.g., base station 106) whether the UE 102 has added at least a portion of the uncompressed data packet to the compression memory and identifying the location of the compression memory to reference. As shown in FIG. 7A, the UDC packet format 700 includes a Packet action field 705, a Checksum field 710, an Option field 720 to indicate the header type (e.g., a value of 00 may indicate UDC), one or more Extension fields 715 and 725, Extension Suboptions (ESubO) fields 730 and 755 that may indicate whether any other suboptions follow, packet flow identifier 735, DPush field 740, MPush field 745, SubO field 750, number of segments field 760, start length field 765 and length to copy length field 775.

The packet action field 705 may be the upper 3 bits of the packet header. Value of 011 for the packet action field indicate full packet compression. In this case, the entire packet is pushed to the compression memory. Value of 010 for the packet action field indicate Header-only compression. In this case, only the header is pushed to compression memory. For the above two packet action values (011, and 010), decompression is performed as indicated by short header or legacy UDC header. Value of 100 for the packet action field indicate match of UDC header to the one used in previous packet and packet is pushed to compression memory based on the previous packet action. Value of 001 for the packet action field indicate compression attempted but no matches found. In this case, the entire packet is pushed to compression memory. Value of 000 for the packet action field indicate No compression. In this case, the packet is not pushed to compression memory. Value of 101 for the packet action field indicate reset compression memory to all zeros. In this case, the entire packet is pushed to compression memory. For these four packet action values (100, 001, 000, and 101), the short header or the legacy UDC header will not be present.

The Checksum field 710 may be 4 bits and used by the decompressor (e.g., the RNC) to detect compression memory Out of Sync conditions between the compressor and decompressor. For packet action field values of 011, 010 and 100, the Checksum field includes the sum of the first 5 bytes of the first match in this packet if there is no short header. If there is a short header, checksum contains the sum of the 5 bytes located at the lookback length pointed by the short header—8. For Packet action field value of 001, the Checksum field includes the sum of the last 5 bytes in the compression memory before the packet that includes the checksum is pushed into the compression memory. For packet action field value of 000, the checksum bits are invalid and shall not be checked. For packet action field value of 101, the checksum bits shall be set to all zeros.

The Extension (E) field 715, for example, is the next 1 bit and is reserved for extensions to the header. This bit may be set to 1 to indicate the presence of header extensions.

Extension field may be set to 0 to indicate no additional Option fields. An Extension Suboptions (ESubO) fields 755 may indicate whether any other suboptions follow. The Packet Flow Identifier 735 may indicate one of 8 IP flows, for example, indicating that packet and metadata corresponding to the identified flow is to be pushed into and read from the memory. The DPush field 740 may indicate that the packet is to be pushed to the compression memory. The MPush field 745 may indicate that metadata of the header (e.g., short UDC header or conventional full UDC header) is to be pushed to the compression memory. This may include pushing metadata explicitly included in the current packet as well as metadata which are referred to from previous packets.

Additionally or alternatively, the number of segments field 760 that may be 5 bits may be used to number of segments that need to be copied to the compression memory. The copy start length 765 that may be used to indicate the start location in the data packet for the segments, and the length of copy field 770 may indicate the length of the segment from the start location that may be copied to the compression memory. Although aspects of the UDC packet format 702 are described with various lengths (e.g., 11 bits for copy start length field), it should be understood by those in the art that such parameters are configurable to various lengths.

FIG. 7B illustrates another example UDC packet format 704 that may be utilized to signal to the receiver (e.g., base station 106) whether the UE 102 has added at least a portion of the uncompressed data packet to the compression memory and identifying the location of the compression memory to reference. As shown in FIG. 7B, the UDC packet format 704 may omit signaling overhead by utilizing the simplified version of copy length field 775 that may be 13 bits that indicates an X number of bytes that are pushed to the compression memory. Upon receiving the UDC packet format 704, the base station 706 may copy the first X number of bytes from the data packet into the network compression memory. The UE 102 may signal the distinction between the UDC packet format 702 illustrated in FIG. 7A and the UDC packet format 704 illustrated in FIG. 7B by utilizing the SubO field 750 that may identify the various header formats.

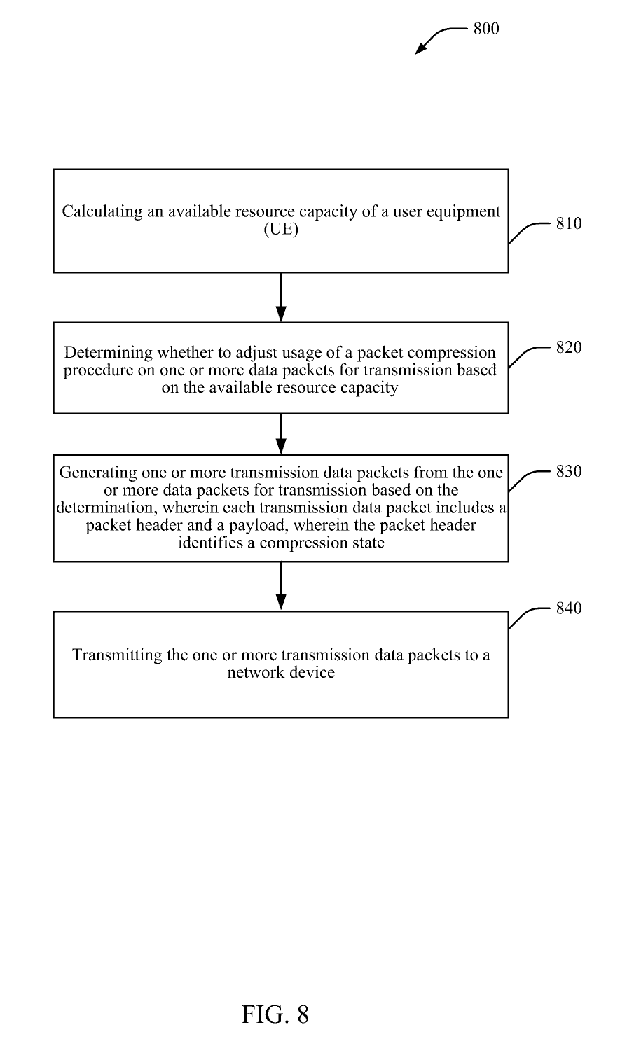

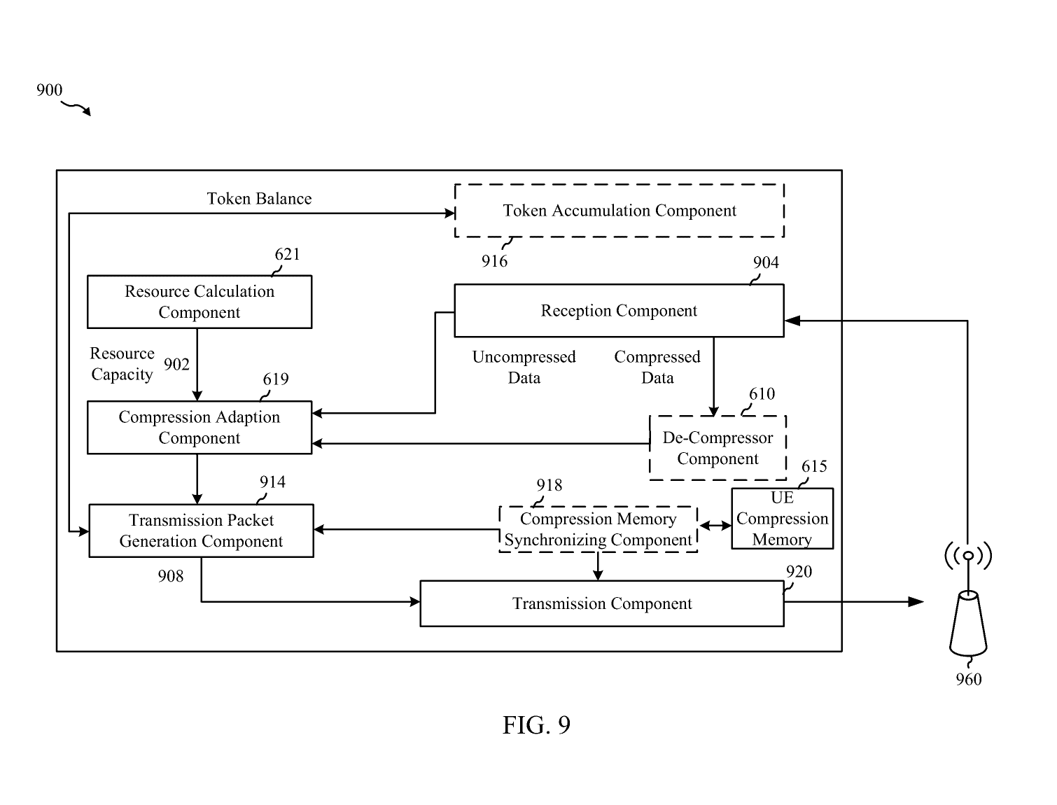

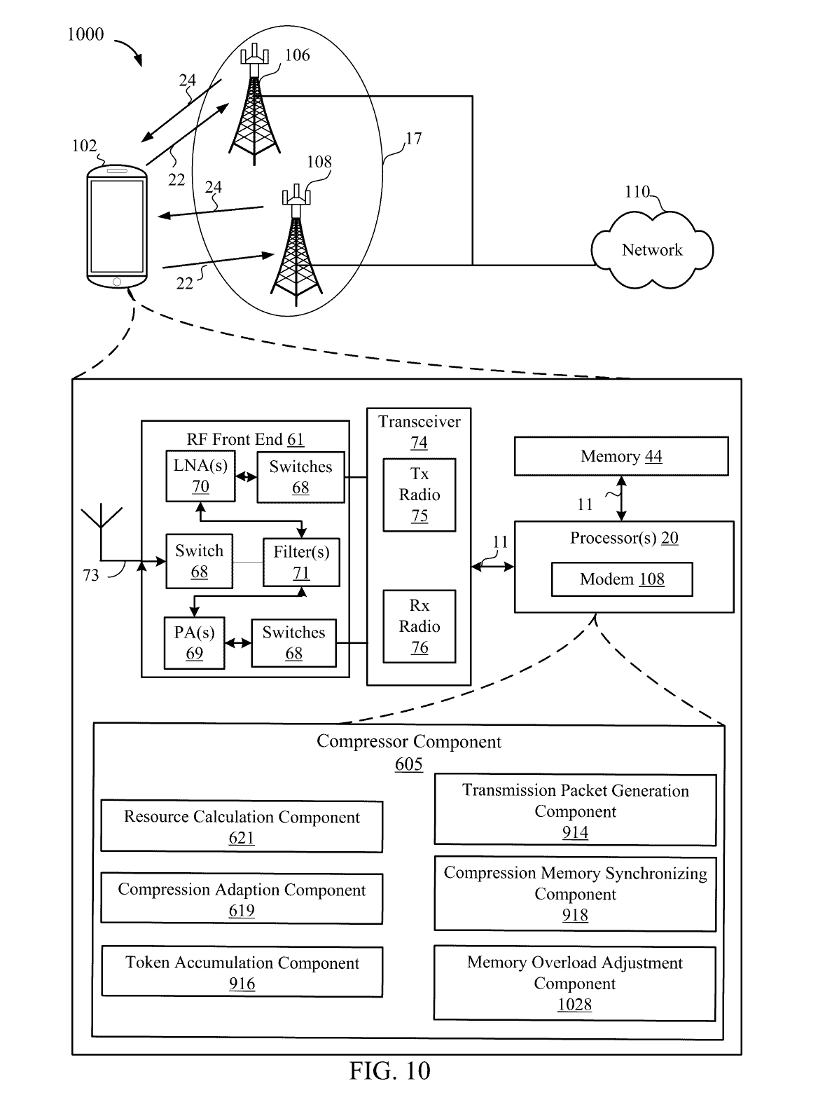

FIG. 8 is a flow chart 800 of a method of wireless communication. The method may be performed by a UE (e.g., the UE 102 of FIGS. 1, 6, 9, and 10, or UE 206 of FIG. 2, or UE 550 of FIG. 5). At 810, the UE may calculate an available resource capacity of a UE. In some examples, calculating the available resource capacity may include determining processor load, bus bandwidth, MIPS, available memory, and/or thermal measurements associated with the UE. In one or more examples, each measurable component (i.e., processor load, bus bandwidth etc.) associated with the resource capacity may be assigned a weight value that is fixed or dynamically configurable. For example, in some cases, the processing load may be weighted higher than the available memory when calculating the available resource capacity. Accordingly, based on the calculations, the UE, at 810, may identify available resource capacity of the UE. Aspects of block 810 may be performed by resource calculation component 621 described with reference to FIGS. 9 and 10.

At 820, the method may further include determining whether to adjust usage of a packet compression procedure on one or more data packets for transmission based on the available resource capacity. Thus, in some examples, determining whether to adjust the usage of the packet compression procedure may comprise determining whether the available resource capacity satisfies a capacity threshold. The capacity threshold may be either fixed threshold value or a dynamically adaptable threshold value. If the available resource capacity exceeds the capacity threshold, the method, at 820, may include enabling the packet compression procedure to perform compression on data packets queued for transmission. Alternatively, if the available resource capacity is less than the capacity threshold, the UE may disable the packet compression procedure. In some aspects, the level of compression performed on data packets may be scalable based on active monitoring of the available resource capacity.

For example, in some aspects, the UE may adjust the packet compression procedure to a first compression state if the available resource capacity fails to satisfy a first capacity threshold, and adjust the packet compression procedure from the first compression state to a second compression state if the available resource capacity further fails to satisfy a second capacity threshold. In the aforementioned example, the first capacity threshold may be higher than the second capacity threshold (e.g., available resource capacity may be higher during the first capacity threshold than a subsequent second capacity threshold). Thus, in accordance with various aspects of the present disclosure, an amount of compression performed during the first compression state may be greater than the amount of compression performed during the second compression state.

Some examples of the first compression state may include compressing each of the one or more data packets scheduled for transmission, while the second compression state may include compressing a subset of the one or more data packets. Thus, in the second instance, the UE may transmit to the base station some data packets that are compressed, while other data packets may be uncompressed. Additionally or alternatively, the second compression state may include compressing a first portion of a first data packet of the one or more data packets, while a second portion of the first data packet is left uncompressed. In one or more examples, the compressed portion may be a packet header and the uncompressed portion may be the payload. Aspects of block 820 may be performed by the compression adaption component 619 described with reference to FIGS. 9 and 10.

At 830, the method may include generating one or more transmission data packets from the one or more data packets for transmission based on the determination whether to adjust usage of a packet compression procedure on one or more data packets for transmission based on the available resource capacity. In some examples, each transmission data packet may include a packet header and a payload, wherein the packet header identifies a compression state. In some examples, the UE may generate the one or more transmission data packets by identifying an N number of the one or more data packets queued for transmission and selecting a K number of the one or more data packets for compression from the N number of the one or more data packets. In some aspects, N and the K may be integer values, where N is greater than K. In one or more examples, selecting the K number of the one or more data packets for compression may be based on a fixed pattern or a pseudo-random pattern.

Additionally or alternatively, in some examples, generating the one or more transmission data packets may comprise compressing a portion of at least one of the one or more data packets to form the one or more transmission data packets. For example, each transmission data packet of the one or more transmission data packets may include a compressed portion, an uncompressed portion, or any combination thereof. In some examples, the compressed portion may be a packet header, while the uncompressed portion may be the payload associated with the packet header.

In yet further example, as discussed above, generating the one or more transmission data packet may include compressing a first portion of a first data packet of the one or more data packets to form a first transmission data packet of the one or more transmission data packets. In such instance, the second portion of the first data packet may be left uncompressed. Accordingly, the UE may determine whether to add the second portion of the first data packet (i.e., uncompressed portion) to the compression memory. The UE may signal to the network device via the packet header whether the second portion of the first data packet has been stored in the compression memory and a location of the second portion of the first data packet within the first data packet. Thus, based on the signaling, the network may be configured to retrieve the transmitted packet from the compression memory and synchronize the network compression memory (see FIG. 6) with the UE compression memory (see FIG. 6). Aspects of block 830 may be performed by transmission packet generation component 1018 described with reference to FIGS. 9 and 10.

At 840, the method may include transmitting the one or more transmission data packets to a network device. In some examples, the one or more transmission data packets may be compressed transmission data packets, uncompressed transmission data packets, or partially compressed transmission data packets. In each instance, the packet header associated with each one of the one or more transmission data packet may identify the compression state of the transmission data packet. Aspects of block 840 may be performed by transceiver 1010 described with reference to FIGS. 9 and 10.

FIG. 9 is a conceptual data flow diagram 900 illustrating the data flow between different means/components. In accordance with various aspects of the present disclosure, the resource calculation component 621 may be configured to calculate an available resource capacity 902 of a UE. As discussed above, calculating the available resource capacity may include determining the CPU load, the bus bandwidth, available memory, thermal measurements, and/or MIPS. The available resource capacity 902 information may be forwarded to the compression adaption component 619. The compression adaption component 619 may determine whether to adjust usage of a packet compression procedure on one or more data packets for transmission based on the available resource capacity. In some the compression adaption component 619 may further receive information from token accumulation component 916 regarding token balance accumulated by the apparatus. In some aspects, the tokens may be accumulated by the token accumulation component 916 on a fixed or dynamically configurable rate (e.g., 1 Mbps every 20 ms). The token rate may be adjusted to prevent system resource overload.

Accordingly, the compression adaption component 619 may consider one or both of the resource capacity and the token balance information in determining whether to adjust the packet compression procedures. The transmission packet generation component 914 may be configured to generate one or more transmission data packets 908 from the one or more data packets for transmission based on the determination by the compression adaption component 619. Each transmission data packet 908 may include a packet header and a payload. In some examples, the transmission packet generation component 914 may assign a value to the packet header to identify the compression state of the one or more transmission data packets to the receiver (e.g., base station 960). Accordingly, the transmission data packets 908 generated by the transmission packet generation component 914 may be forwarded to the transmission component 920 to be wireless transmitted to the base station 960.

Additionally or alternatively, the apparatus may include a compression memory synchronizing component 918 for determining whether to add at least a portion of the data packet to a compression memory and generating signaling messages to the network device via the packet header whether at least a portion of the data packet has been stored in the compression memory and a location of the portion of the data packet within the data packet. The signaling information may be transmitted by the transmission component 920 to the base station 960. In some aspects, the compression memory synchronizing component 918 may maintain synchronization between the UE compression memory 615 and the base station compression memory (not shown).

In yet further examples, the apparatus may be configured to determine whether the processing of the compressed data blocks received from the base station 960 at the reception component 904 may impact the system resource performance. For example, the de-compressor component 610 may decompress the received data blocks for processing. However, if the resource capacity is less than the capacity threshold, the apparatus may request the compression adaption component 619 to determine the compression adjustments that should be requested of the base station 960 in order to maximize available system resources. As such, the compression adaption component 619 may generate a control message for the base station 960, requesting the base station 960 to dynamically adjust the network packet compression procedures based on the available UE resource capacity.

FIG. 10 illustrates a detailed view of components and sub-components of the UE 115 of the UE described with reference to FIG. 6 and the process performed by the UE in FIG. 9. As illustrated in FIG. 10, in an aspect, a wireless communication system 1000 includes at least one UE 102 in communication coverage of at least one base station 106 and other eNodeBs 106-a. The wireless communication system 1000 may be an example of evolved packet system 100 described with reference to FIG. 1 In some examples, the UE 102 and/or the base station 106 may be an example of UE 102 and base station 106 described with reference to FIG. 1.

In an aspect, the UE 102 may include one or more processors 20 and/or memory 44 that may operate in combination with compressor component 605 to perform the functions, methodologies (e.g., method 800 of FIG. 8), or methods presented in the present disclosure. In accordance with the present disclosure, the compressor component 605 may include a resource calculation component 621 for calculating an available resource capacity of a UE 102. In some aspects, the compressor component 605 may further include a compression adaption component 619 to manage a flow control of data packets associated with an uplink data compression. The compressor component 605 may further include token accumulation component 916 to receive information regarding token balance accumulated by the UE 102. Additionally or alternatively, the compressor component 605 may include transmission packet generation component 914 to generate one or more transmission data packets from the one or more data packets for transmission based on the determination by the compression adaption component 619. Further, in some examples, the compressor component 605 may include compression memory synchronizing component 918 determining whether to add at least a portion of the data packet to a compression memory and generating signaling messages to the network device via the packet header whether at least a portion of the data packet has been stored in the compression memory and a location of the portion of the data packet within the data packet.

In yet further examples, the compressor component 605 may include memory overload adjustment component 1028 for detecting memory overload condition associated with a compression memory. In some aspects, the determining comprises disabling the packet compression procedure based on the detecting. Additionally or alternatively, the memory overload adjustment component 1028 may be configured for releasing the compression memory based on the detecting the memory overload condition and monitoring the compression memory to determine that an available memory level meets an available memory threshold associated with avoidance of the memory overload condition. As such, the compressor component 605 may enable the packet compression procedure upon determining that the available memory level meets the available memory threshold.

The one or more processors 20 may include a modem 108 that uses one or more modem processors. The various functions related to the compressor component 605 may be included in modem 108 and/or processor 20 and, in an aspect, can be executed by a single processor, while in other aspects, different ones of the functions may be executed by a combination of two or more different processors. For example, in an aspect, the one or more processors 20 may include any one or any combination of a modem processor, or a baseband processor, or a digital signal processor, or a transmit processor, or a transceiver processor associated with transceiver 74, or a system-on-chip (SoC). In particular, the one or more processors 20 may execute functions and components included in the compressor component 605.

In some examples, the compressor component 605 and each of the sub-components may comprise hardware, firmware, and/or software and may be configured to execute code or perform instructions stored in a memory (e.g., a computer-readable storage medium, such as memory 44 discussed below). Moreover, in an aspect, UE 102 may include RF front end 61 and transceiver 74 for receiving and transmitting radio transmissions, for example, wireless communications (e.g., communications 22 and 24) transmitted by base station 106. For example, transceiver 74 may receive a packet transmitted by the base station 106. UE 102, upon receipt of an entire message, may decode the message and perform a cyclic redundancy check (CRC) to determine whether the packet was received correctly. For example, transceiver 74 may communicate with modem 108 to transmit messages generated by compressor component 605 and to receive messages and forward them to the de-compressor component 610 (see FIG. 6).

RF front end 61 may be connected to one or more antennas 73 and can include one or more switches 68, one or more amplifiers (e.g., power amplifiers (PAs) 69 and/or low-noise amplifiers 70), and one or more filters 71 for transmitting and receiving RF signals on the uplink channels and downlink channels. In an aspect, components of RF front end 61 can connect with transceiver 74. Transceiver 74 may connect to one or more modem 108 and processor 20.

Transceiver 74 may be configured to transmit (e.g., via transmitter radio 75) and receive (e.g., via receiver radio 76) and wireless signals through antennas 73 via RF front end 61. In an aspect, transceiver may be tuned to operate at specified frequencies such that UE 102 can communicate with, for example, base stations 106. In an aspect, for example, modem 108 can configure the transceiver 74 to operate at a specified frequency and power level based on the UE configuration of the UE 115 and communication protocol used by modem.

UE 102 may further include a memory 44, such as for storing data used herein and/or local versions of applications or compressor component 605 and/or one or more of its subcomponents being executed by processor 20. Memory 44 can include any type of computer-readable medium usable by a computer or processor 20, such as random access memory (RAM), read only memory (ROM), tapes, magnetic discs, optical discs, volatile memory, non-volatile memory, and any combination thereof. In an aspect, for example, memory 44 may be a computer-readable storage medium that stores one or more computer-executable codes defining waveform generation component 305 and/or one or more of its subcomponents. Additionally or alternatively, the UE 115 may include a bus 11 for coupling the RF front end 61, transceiver 74, memory 44 and processor 20 and to exchange signaling information between each of the components and/or subcomponents of the UE 102.

It is understood that the specific order or hierarchy of blocks in the processes / flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for flow control associated with uplink data compression in a wireless communication system, comprising:
calculating, by a processor, an available resource capacity of a user equipment (UE);
determining whether to adjust usage of a packet compression procedure on one or more data packets for transmission based on the available resource capacity;
generating one or more transmission data packets from the one or more data packets for transmission based on the determination, wherein each transmission data packet includes a packet header and a payload, wherein the packet header identifies a compression state; and
transmitting, via a transceiver, the one or more transmission data packets to a network device.

2. The method of claim 1, wherein the generating the one or more transmission data packets comprises:
identifying an N number of the one or more data packets queued for transmission;
selecting a K number of the one or more data packets for compression from the N number of the one or more data packets, wherein the N and the K are integer values, and N is greater than K; and
compressing the K number of the one or more data packets based on the selection.

3. The method of claim 1, wherein the generating the one or more transmission data packets comprises:
compressing a portion of at least one of the one or more data packets to form the one or more transmission data packets, wherein each transmission data packet of the one or more transmission data packets includes a compressed portion, an uncompressed portion, or any combination thereof.

4. The method of claim 1, wherein the generating the one or more transmission data packets comprises:
compressing a first portion of a selected data packet of the one or more data packets to form a selected transmission data packet of the one or more transmission data packets, wherein a second portion of the selected data packet is left uncompressed;
determining whether to add the second portion of the selected data packet to a compression memory; and
signaling to the network device via the packet header whether the second portion of the selected data packet has been stored in the compression memory and a corresponding location.

5. The method of claim 1, wherein the determining whether to adjust usage of the packet compression procedure on the one or more data packets for transmission comprises:
determining a data packet length associated with a first data packet of the one or more data packets for transmission; and
enabling the packet compression procedure when a token balance at the UE exceeds the data packet length; or
disabling the packet compression procedure when the token balance is less than or equal to the data packet length.

6. The method of claim 5, wherein the determining whether to adjust usage of the packet compression procedure on the one or more data packets for transmission comprises:
determining a packet header length associated with the first data packet of the one or more data packets for transmission; and
disabling the packet compression procedure when the token balance fails to exceed the packet header length or
enabling the packet compression procedure by compressing a packet header associated with the first data packet when the token balance exceeds the packet header length.

7. The method of claim 5, wherein the determining whether to adjust usage of the packet compression procedure on the one or more data packets for transmission comprises:
determining a packet length associated with the first data packet of the one or more data packets for transmission;
determining that the token balance is less than the packet length; and
compressing a first portion of the first data packet based on the token balance, wherein a second portion of the first data packet is left uncompressed.

8. The method of claim 7, further comprising:
entering a wait period based on the determining that the token balance is less than the packet length;
monitoring the token balance during the wait period; and
compressing the second portion of the first data packet upon acquiring additional tokens.

9. The method of claim 1, wherein the determining whether to adjust the usage of the packet compression procedure comprises:
determining whether the available resource capacity of the UE satisfies a first capacity threshold, wherein the first capacity threshold is either a fixed threshold value or a dynamically adaptable threshold value; and
adjusting the packet compression procedure to a first compression state if the available resource capacity fails to satisfy the first capacity threshold.

10. The method of claim 9, further comprising:
determining whether the available resource capacity of the UE satisfies a second capacity threshold, wherein the second capacity threshold is either the fixed threshold value or the dynamically adaptable threshold value; and
adjusting the packet compression procedure from the first compression state to a second compression state if the available resource capacity fails to satisfy the second capacity threshold, wherein an amount of compression performed during the first compression state is greater than the amount of compression performed during the second compression state.

11. The method of claim 1, wherein the available resource capacity includes at least one of a bus bandwidth, or an available memory, or a thermal measurement, or a central processing unit (CPU) load.

12. The method of claim 1, further comprising:
determining whether to adjust the usage of the packet compression procedure associated with the network device for the one or more data packets received at the UE based on the available resource capacity; and
transmitting, from the UE, a control message to the network device to request the network device to adjust the packet compression procedures for the one or more data packets scheduled for transmission to the UE.

13. A user equipment for flow control associated with uplink data compression in a wireless communication system, comprising:
a processor;
a memory coupled to the processor, wherein the memory includes instructions executable by the processor to:
calculate an available resource capacity of a user equipment (UE);
determine whether to adjust usage of a packet compression procedure on one or more data packets for transmission based on the available resource capacity;
generate one or more transmission data packets from the one or more data packets for transmission based on the determination, wherein each transmission data packet includes a packet header and a payload, wherein the packet header identifies a compression state; and
transmit, via a transceiver, the one or more transmission data packets to a network device.

14. The user equipment of claim 13, wherein the instructions in generating the one or more transmission data packets are further executable by the processor to:
identify an N number of the one or more data packets queued for transmission;
select a K number of the one or more data packets for compression from the N number of the one or more data packets, wherein the N and the K are integer values, and N is greater than K; and
compress the K number of the one or more data packets based on the selection.

15. The user equipment of claim 13, wherein the instructions in generating the one or more transmission data packets are further executable by the processor to:
compress a portion of at least one of the one or more data packets to form the one or more transmission data packets, wherein each transmission data packet of the one or more transmission data packets includes a compressed portion, an uncompressed portion, or any combination thereof.

16. The user equipment of claim 13, wherein the instructions in generating the one or more transmission data packets are further executable by the processor to:
compress a first portion of a selected data packet of the one or more data packets to form a selected transmission data packet of the one or more transmission data packets, wherein a second portion of the selected data packet is left uncompressed;
determine whether to add the second portion of the selected data packet to a compression memory; and
signal to the network device via the packet header whether the second portion of the selected data packet has been stored in the compression memory and a corresponding location.

17. The user equipment of claim 13, wherein the instructions for determining whether to adjust usage of the packet compression procedure on the one or more data packets are further executable by the processor to:
determine a data packet length associated with a first data packet of the one or more data packets for transmission; and
enable the packet compression procedure when a token balance at the UE exceeds the data packet length; or
disable the packet compression procedure when the token balance is less than or equal to the data packet length.

18. The user equipment of claim 17, wherein the instructions for determining whether to adjust usage of the packet compression procedure on the one or more data packets are further executable by the processor to:
determine a packet header length associated with the first data packet of the one or more data packets for transmission; and
disable the packet compression procedure when the token balance fails to exceed the packet header length or
enable the packet compression procedure by compressing a packet header associated with the first data packet when the token balance exceeds the packet header length.

19. The user equipment of claim 17, wherein the instructions for determining whether to adjust usage of the packet compression procedure on the one or more data packets are further executable by the processor to:
determine a packet length associated with the first data packet of the one or more data packets for transmission;
determine that the token balance is less than the packet length; and
compress a first portion of the first data packet based on the token balance, wherein a second portion of the first data packet is left uncompressed.

20. The user equipment of claim 19, wherein the instructions are further executable by the processor to:
enter a wait period based on the determining that the token balance is less than the packet length;
monitor the token balance during the wait period; and
compress the second portion of the first data packet upon acquiring additional tokens.

21. The user equipment of claim 13, wherein the instructions for determining whether to adjust usage of the packet compression procedure on the one or more data packets are further executable by the processor to:
determine whether the available resource capacity of the UE satisfies a first capacity threshold, wherein the first capacity threshold is either a fixed threshold value or a dynamically adaptable threshold value; and
adjust the packet compression procedure to a first compression state if the available resource capacity fails to satisfy the first capacity threshold.

22. The user equipment of claim 13, wherein the instructions are further executable by the processor to:
determine whether to adjust the usage of the packet compression procedure associated with the network device for the one or more data packets received at the UE based on the available resource capacity; and
transmit, from the UE, a control message to the network device to request the network device to adjust the packet compression procedures for the one or more data packets scheduled for transmission to the UE.

23. A user equipment for flow control associated with uplink data compression in a wireless communication system, comprising:
means for calculating an available resource capacity of a user equipment (UE);
means for determining whether to adjust usage of a packet compression procedure on one or more data packets for transmission based on the available resource capacity;
means for generating one or more transmission data packets from the one or more data packets for transmission based on the determination, wherein each transmission data packet includes a packet header and a payload, wherein the packet header identifies a compression state; and
means for transmitting the one or more transmission data packets to a network device.

24. The user equipment of claim 23, wherein the means for generating the one or more transmission data packets comprises:
means for identifying an N number of the one or more data packets queued for transmission;
means for selecting a K number of the one or more data packets for compression from the N number of the one or more data packets, wherein the N and the K are integer values, and N is greater than K; and
means for compressing the K number of the one or more data packets based on the selection.

25. The user equipment of claim 23, wherein the means for generating the one or more transmission data packets comprises:
means for compressing a portion of at least one of the one or more data packets to form the one or more transmission data packets, wherein each transmission data packet of the one or more transmission data packets includes a compressed portion, an uncompressed portion, or any combination thereof.

26. The user equipment of claim 23, wherein the means for generating the one or more transmission data packets comprises:
means for compressing a first portion of a selected data packet of the one or more data packets to form a selected transmission data packet of the one or more transmission data packets, wherein a second portion of the selected data packet is left uncompressed;
means for determining whether to add the second portion of the selected data packet to a compression memory; and
means for signaling to the network device via the packet header whether the second portion of the selected data packet has been stored in the compression memory and a corresponding location.

27. The user equipment of claim 23, wherein the means for determining whether to adjust usage of the packet compression procedure on the one or more data packets for transmission comprises:
means for determining a data packet length associated with a first data packet of the one or more data packets for transmission; and
means for enabling the packet compression procedure when a token balance at the UE exceeds the data packet length; or
means for disabling the packet compression procedure when the token balance is less than or equal to the data packet length.

28. The user equipment of claim 27, wherein the means for determining whether to adjust usage of the packet compression procedure on the one or more data packets for transmission comprises:
means for determining a packet header length associated with the first data packet of the one or more data packets for transmission; and
means for disabling the packet compression procedure when the token balance fails to exceed the packet header length or
means for enabling the packet compression procedure by compressing a packet header associated with the first data packet when the token balance exceeds the packet header length.

29. The user equipment of claim 27, wherein the means for determining whether to adjust usage of the packet compression procedure on the one or more data packets for transmission comprises:
means for determining a packet length associated with the first data packet of the one or more data packets for transmission;
means for determining that the token balance is less than the packet length; and
means for compressing a first portion of the first data packet based on the token balance, wherein a second portion of the first data packet is left uncompressed.

30. A computer-readable medium storing code for flow control associated with uplink data compression in a wireless communication system, the code comprising instructions executable to:
calculate an available resource capacity of a user equipment (UE);
determine whether to adjust usage of a packet compression procedure on one or more data packets for transmission based on the available resource capacity;
generate one or more transmission data packets from the one or more data packets for transmission based on the determination, wherein each transmission data packet includes a packet header and a payload, wherein the packet header identifies a compression state; and
transmit the one or more transmission data packets to a network device.
